(19) United States
(12) Patent Application Publication
(10) Pub. No.: US 2011/0085290 A1
(43) Pub. Date: Apr. 14, 2011

(54) STAND-UP EXTERNAL DATA ACCESS DEVICE

(76) Inventor: Chia-Che HU, Jhonghe City (TW)

(21) Appl. No.: 12/578,680

(22) Filed: Oct. 14, 2009

(51) Int. Cl. G06F 1/16

(52) U.S. Cl. 361/679.31

(57) ABSTRACT

A stand-up external data access device includes a main body and a rotatable leg. The main body has a flat casing. One side of the flat casing is provided with a receiving portion. The rotatable leg has a plate and a connecting portion provided on a surface of the plate. The connecting portion is pivotally connected to the receiving portion and rotatable with respect to the casing. A width of the plate after being rotated out of the receiving portion is larger than a width of the casing in its thickness direction. With this structure, the supporting area for stabilizing the bottom of the stand-up main body can be increased, so that the main body can stand up more stably.

### BACKGROUND OF THE INVENTION

1. Field of the Invention

The present invention relates to a data access device, and in particular to a stand-up external data access device.

2. Description of Prior Art

There are various kinds of data access devices for storing and reading data, such as hard disk drivers, soft disk drivers, optical disk drivers or the like. Some of these data access devices are fixed within an electronic apparatus, and the others are external data access devices in order not to occupy the memory capacity of the electronic apparatus or increase the mobility in use. Such an external data access device is easy to carry and it can be used to back-up the data. Because of these advantages, the external data access device has become a necessary device in our daily life.

Taiwan Patent No. M291560 discloses a supporting apparatus of an external data access device, which includes a hollow casing and a base. The hollow casing includes a frame and at least one heat-dissipating metallic plate provided on one side surface of the frame. The bottom surface of the frame is provided with a through-hole. The base is provided on the bottom surface of the frame, and it includes a circuit board provided within the base and an opening provided on the top surface of the base to correspond to the through-hole.

However, in practice, the above-mentioned supporting apparatus of an external data access device still has problems as follows. Since the base and the hollow casing that are bulky with a large footprint are used to accommodate the external data access device, it will occupy a lot of space and makes a user to feel inconvenient to carry outdoors. Further, such an external data access device is constituted of a number of complicated components, which will inevitably increase the material cost and the time for assembly. Thus, the practicability and cost-effectiveness of this conventional data access device will be deteriorated greatly.

On the other hand, some external data access devices are made compact in order not to occupy a lot of space. However, such a compact data access device cannot reduce its footprint when it is laid horizontally. Although such a compact data access device can reduce its footprint when it is erected vertically, it may topple over easily and cannot stand up stably.

Therefore, it is an important issue for the present Inventor to solve the above-mentioned problems.

### SUMMARY OF THE INVENTION

The present invention is to provide a stand-up external data access device, in which a rotatable leg can rotate with respect to the casing, thereby increasing the supporting area for erecting a main body. In this way, the main body can stand up stably.

The present invention is to provide a stand-up external data access device which includes a main body and a rotatable leg. The main body has a flat casing. One side of the flat casing is provided with a receiving portion. The rotatable leg has a plate and a connecting portion provided on one surface of the plate. The connecting portion is pivotally connected to the receiving portion and rotatable with respect to the casing. The width of the plate after being rotated out of the receiving portion is larger than a width of the casing in its thickness direction.

Further, the present invention has advantageous features as follows. When the main body stands up, its footprint can be reduced greatly. After using, the rotatable leg can be rotatably received in a recess of the casing, thereby increasing the aesthetic feeling of the external appearance of the device. By means of slide-proof pads on the bottom surface of the rotatable leg, the device can stand up more stably without any sliding.

### BRIEF DESCRIPTION OF THE DRAWINGS

FIG. 1 is a perspective view showing the external appearance of the data access device of the present invention;

FIG. 2 is a partially exploded view showing some components of the data access device of the present invention;

FIG. 3 is an assembled view showing the data access device of the present invention;

FIG. 4 is a partially enlarged view showing the region A in FIG. 3;

FIG. 5 is a partially cross-sectional view showing the data access device of the present invention;

FIG. 6 is a schematic view showing the state after the rotatable leg of the data access device of the present invention is rotated out of the receiving portion;

FIG. 7 is a cross-sectional view of FIG. 6 taken from another viewing angle; and

FIG. 8 is a perspective view showing the external appearance of the data access device of the present invention after the rotatable leg is rotated out of the receiving portion.

### DETAILED DESCRIPTION OF THE INVENTION

The characteristics and technical contents of the present invention will be described with reference to the accompanying drawings. However, the drawings are illustrative only but not used to limit the present invention.

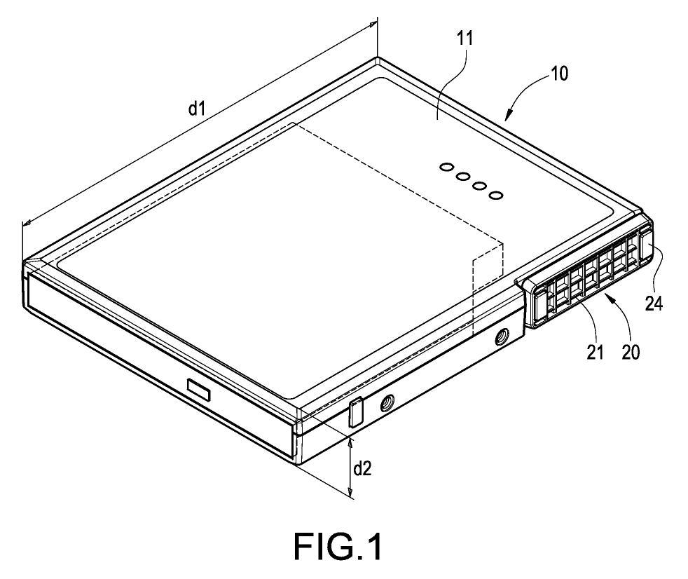

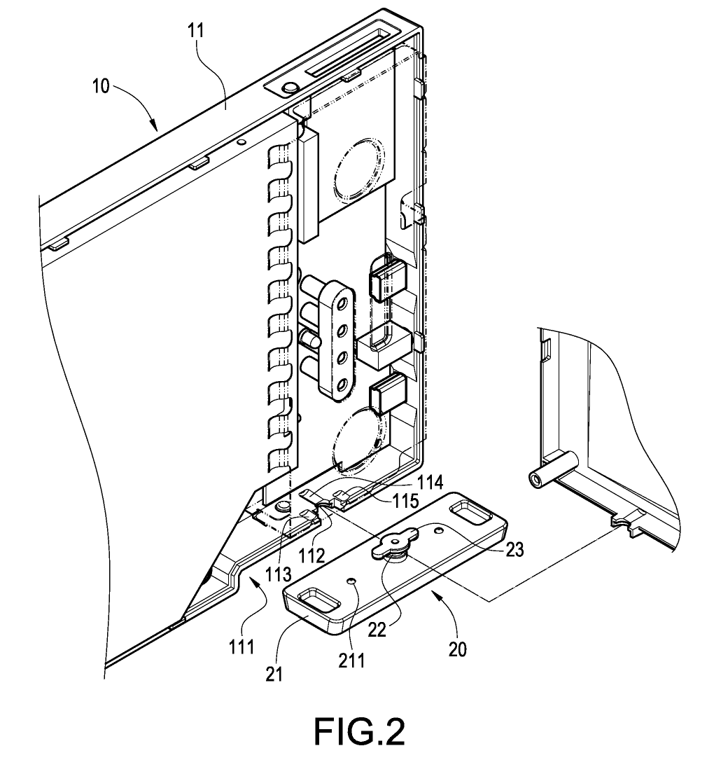

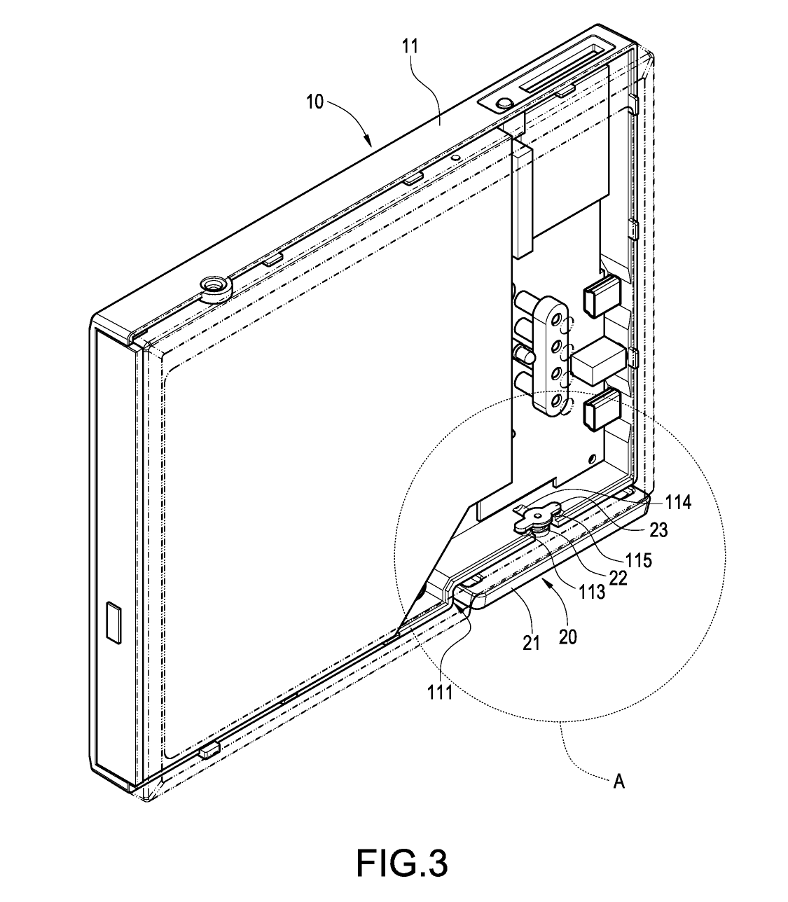

The present invention provides a stand-up external data access device, which may be an external hard disk driver, optical disk driver (DVD-R, DVD-RW) or other suitable devices for storing and/or reading data. In the present embodiment, an optical disk driver is used as an example for illustration. Please refer to FIGS. 1 to 3. The data access device includes a main body 10 and a rotatable leg 20.

The main body 10 comprises a flat rectangular casing 11. The casing 11 is constituted of two boxes. The distance dl in the length direction of the casing 11 is far larger than the distance d2 in the thickness direction thereof. The interior of the casing 11 is arranged with a disk driving tray, data pickup lenses, connecting ports, and electrical units for electrically connecting respective elements or modules, which are conventional and thus the description thereof is omitted for clarity. One side of the casing 11 in the thickness direction is formed with a recess 111. The middle of the recess 111 is provided with a receiving portion 112. In the present embodiment, the receiving portion 112 is a notch. The inner wall of the casing 11 is provided with a front groove 113, a rear groove 114 and a middle groove 115 at positions corresponding to the outer periphery of the receiving portion 112. These three grooves 113, 114, 115 are parallel to each other.

The rotatable leg 20 has a rectangular plate 21, a connecting portion 22 and an arm 23. The profile of the rectangular plate 21 corresponds to that of the recess 111, so that the width of the plate 21 is identical to the distance d2 in the thickness direction of the casing 11. The bottom surface of the rectangular plate 21 is in flush with the side surface of the casing 11 when the rotatable leg 20 is attached to the main body 10. Further, the surface of the plate 21 facing the casing 11 has two locking protrusions 211 for abutting the casing 11. In the present embodiment, the connecting portion 22 is a pivot. The connecting portion 22 protrudes from the surface of the plate 21 facing the casing 11 and is pivotally connected in the receiving portion 112. The arm 23 is fixed to a distal end of the connecting portion 22. The arm 23 has two positioning posts 231 protruding toward the inner wall of the casing 11. The positioning posts 231 can be selectively inserted into two of the grooves 113, 114 and 115. The rectangular plate 21 is provided with two slide-proof pads 24 at a surface away from the casing 11, whereby the main body 10 can stand up more stably without any sliding.

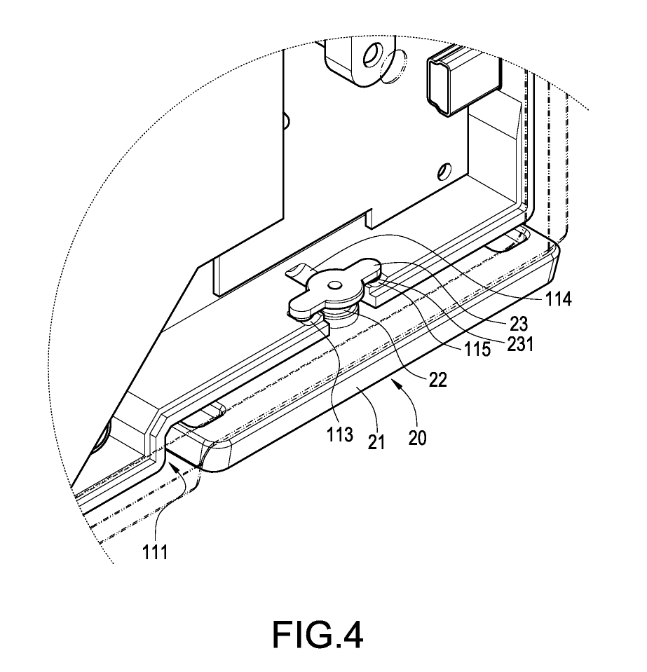

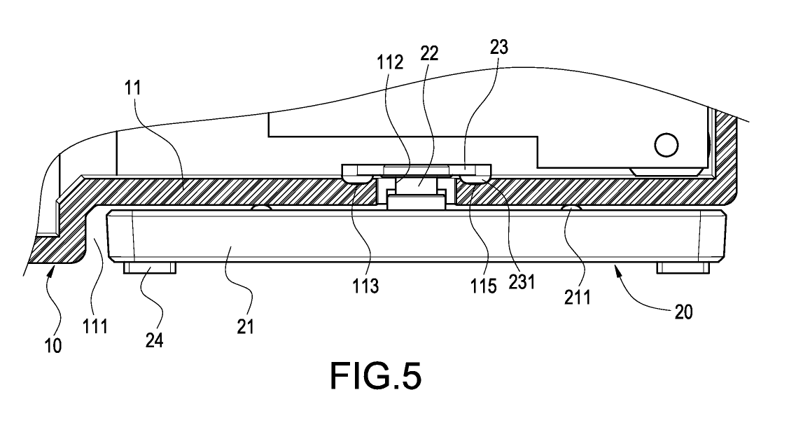

Please refer to FIGS. 4 and 5. In assembly, the connecting portion 22 of the rotatable leg 20 is inserted into the receiving portion 112 of the casing 11 with the two positioning posts 231 of the arm 23 being inserted into the front groove 113 and the rear groove 114 respectively. The two locking protrusions 211 elastically abut the outer surface of the casing 11 (FIG. 5). Then, the two boxes of the casing 11 are assembled with each other by means of screw elements.

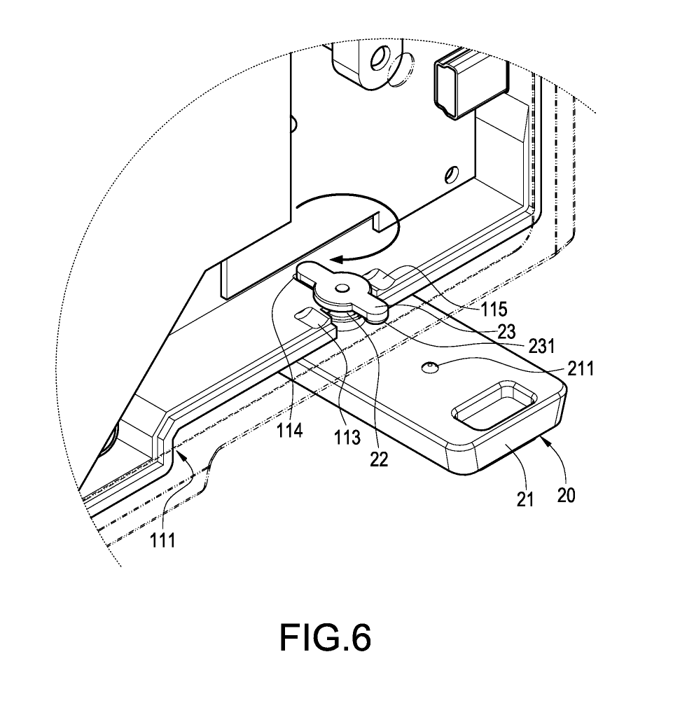

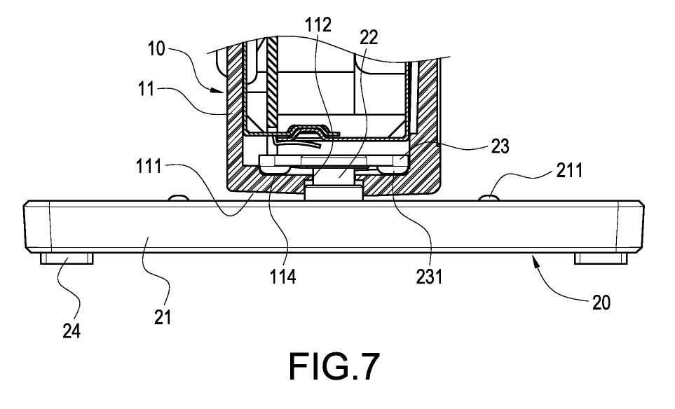

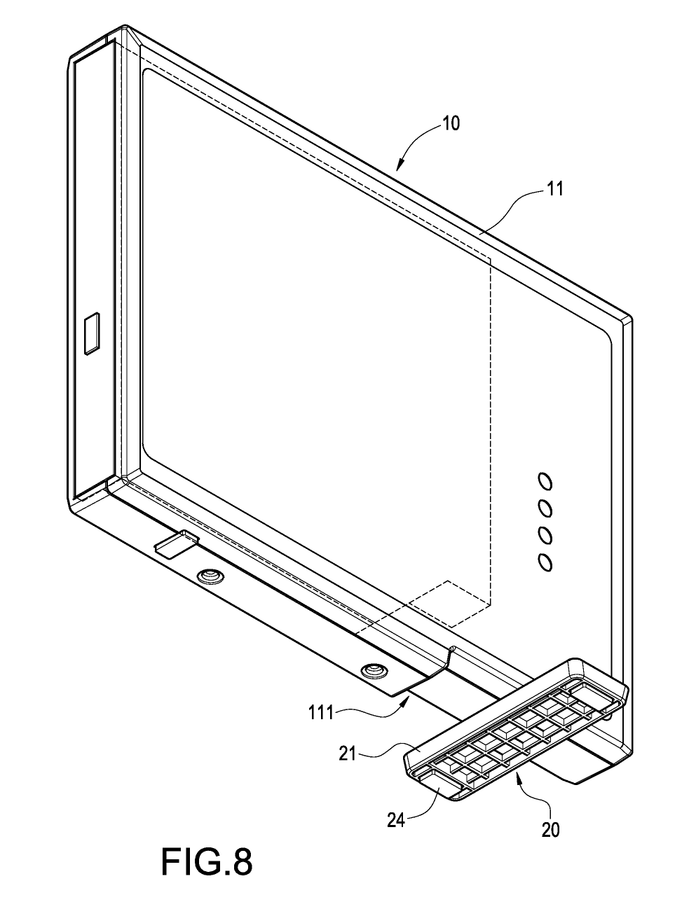

Please refer to FIGS. 6 to 8. In use, if the user intends to erect the main body 10, the main body 10 may toppled over easily because its footprint is small. Thus, the user can rotate the rectangular plate 21 of the rotatable leg 20 in such a manner that the two positioning posts 231 rotate out of the front groove 113 and the rear groove 114. After the rectangular plate 21 is rotated up to 90 degrees, the two positioning posts 231 can be inserted into the middle groove 115. At this time, since the width of the rectangular plate 21 after rotating out of the receiving portion 112 is larger than the width of the casing 11 in the thickness direction thereof, the main body 10 can stand up stably (FIG. 8).

According to the above, the stand-up external data access device according to the present invention really demonstrates industrial applicability, novelty and inventive steps. Further, the structure of the present invention has not been seen in product of the same kind or let in public use. Thus, the present invention conforms to the requirements for a utility model patent.

What is claimed is:

1. A stand-up external data access device, comprising:
a main body having a flat casing, one side of the flat casing being provided with a receiving portion; and
a rotatable leg having a plate and a connecting portion provided on a surface of the plate, the connecting portion being pivotally connected in the receiving portion and rotatable with respect to the casing,
wherein a width of the plate after being rotated out of the receiving portion is larger than a width of the casing in its thickness direction.

2. The stand-up external data access device according to claim 1, wherein the receiving portion is a notch provided in the casing, and the connecting portion is a pivot extending from the plate and being pivotally connected in the notch.

3. The stand-up external data access device according to claim 2, wherein the side of the flat casing is formed with a recess, and the notch is formed in the recess.

4. The stand-up external data access device according to claim 3, wherein the casing is provided with a front groove, a rear groove and a middle groove around the notch, the three grooves are parallel to each other, the rotatable leg further comprises an arm fixed to a distal end of the pivot, and the arm has two positioning posts for inserting into the grooves selectively.

5. The stand-up external data access device according to claim 3, wherein the plate is provided with a slide-proof pad on a surface away from the casing.

6. The stand-up external data access device according to claim 5, wherein the plate is provided on a surface adjacent to the casing with a locking protrusion for abutting the casing.

7. The stand-up external data access device according to claim 1, wherein the side of the flat casing is formed with a recess, and the receiving portion is provided in the recess.

8. The stand-up external data access device according to claim 7, wherein the casing is provided with a front groove, a rear groove and a middle groove around the notch, the three grooves are parallel to each other, the rotatable leg further comprises an arm fixed to a distal end of the pivot, and the arm has two positioning posts for inserting into the grooves selectively.

9. The stand-up external data access device according to claim 7, wherein the plate is provided with a slide-proof pad on a surface away from the casing.

10. The stand-up external data access device according to claim 9, wherein the plate is provided on a surface adjacent to the casing with a locking protrusion for abutting the casing.
